(19) United States
(12) Patent Application Publication
(10) Pub. No.: US 2025/0173781 A1
(43) Pub. Date: May 29, 2025

(54) CONFIGURABLE TRIGGER-BASED EVENT PROCESSING

(71) Applicant: Stripe, Inc., South San Francisco, CA (US)

(72) Inventors: Graham RHODES, Churchtown (IE); Michael YANG, Seattle, WA (US); Henry FUZ, Kennett Square, PA (US); Fried FILLER, Zürich (CH); Chihhung LIN, Bothell, WA (US)

(21) Appl. No.: 18/521,983

(22) Filed: Nov. 28, 2023

(51) Int. Cl. G06Q 40/00

(52) U.S. Cl. CPC G06Q 40/00

(57) ABSTRACT

Aspects of the subject technology include receiving a selection of a trigger event, a set of workflows associated with the trigger event, wherein each workflow is assigned a respective priority attribute, and a set of custom expressions, wherein each custom expression corresponds to a respective workflow and specifies one or more conditions associated with the trigger event. Aspects also include receiving an occurrence of the trigger event and, in response to a determination that the trigger event matches a custom expression for at least one workflow, performing a workflow of the set of workflows having a greatest priority and for which the associated respective custom expression is satisfied, wherein performing a workflow includes performing a set of recovery actions. Aspects also include, in response to a determination that the trigger event does not match any of the respective sets of custom expressions, performing a default workflow.

### TECHNICAL FIELD

The present description generally relates to digital event processing and, more particularly, to techniques for creating digital workflows.

### BACKGROUND

Revenue recovery is an aspect of digital commerce that plays a role in helping a business maintain cash flow and minimize revenue loss. Revenue recovery may include identifying, addressing, and/or recapturing lost or potentially lost revenue in, for example, the e-commerce environment. Lost revenue can occur due to various reasons, such as failed payments, expired credit cards, or customer disputes.

Dunning, on the other hand, is an aspect of revenue recovery. Dunning involves a systematic approach to communicating with customers who, for example, have failed to make timely payments or whose payment methods have encountered issues. A goal of dunning is to gently nudge customers toward resolving payment issues and completing their transactions. Effective dunning not only helps recover revenue but also can maintain positive customer relationships by offering support and flexibility in resolving payment difficulties.

Revenue recovery in the context of digital commerce can be a nuanced process often unsuitable for one-size-fits-all approaches. Instead, revenue recovery may be a strategic business initiative that hinges on numerous factors particular to each merchant. Such factors include the strength of the brand, quality of customer relationships, customer tenure, the nature of the business, subscription interval, and the like. To maximize the chances of recovering lost revenue, merchants may require a high degree of flexibility in their approach to revenue recovery. However, existing approaches for revenue recovery in the context of digital commerce may lack the flexibility for merchants to properly address such nuanced processes and workflows.

### BRIEF DESCRIPTION OF THE DRAWINGS

Certain features of the subject technology are set forth in the appended claims. However, for the purpose of explanation, several embodiments of the subject technology are set forth in the following figures.

FIG. 1 illustrates an example network environment in which the subject technology may be implemented, in accordance with one or more embodiments.

FIG. 2 depicts an example electronic device that may implement the subject technology, in accordance with one or more embodiments.

FIG. 3 depicts a process flow diagram for selectively performing workflows in response to trigger events, in accordance with one or more embodiments.

FIG. 4 depicts an example interface for defining a trigger, in accordance with one or more embodiments.

FIG. 5 depicts an example interface for defining a condition, in accordance with one or more embodiments.

FIG. 6 depicts an example interface for defining a workflow, in accordance with one or more embodiments.

FIG. 7 depicts a flow diagram of an example process for managing one or more revenue recovery workflows, in accordance with one or more embodiments.

FIG. 8 depicts an example electronic system with which aspects of the present disclosure may be implemented, in accordance with one or more embodiments.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other embodiments. In one or more embodiments, structures and components are shown in block diagram form in order to avoid obscuring the concepts of the subject technology.

A flexible approach to automated revenue recovery workflows may allow merchants to segment their customer base effectively and select the most appropriate revenue recovery actions for each specific customer and/or scenario. For instance, a well-established brand with loyal, long-term customers may employ personalized recovery efforts that prioritize maintaining the customer relationship. In contrast, a newer, transactional business might focus on automated reminders and incentives to re-engage customers with overdue payments. However, to provide such flexibility would require technical expertise for programming software to tailor a revenue recovery program for each individual merchant.

Aspects of the subject technology include a platform that allows merchants to generate customized revenue recovery workflows without having to directly edit and/or create computer code. With the subject technology, merchants may use a graphical user interface to specify triggers, conditions, and/or actions that model their business processes, thereby allowing them to create custom workflows for tasks such as collecting on failed payments, preventing churn, facilitating customer communication, and the like, without the need to understand and/or develop computer code thereby conserving developer resources. Workflows may be created with user graphical elements that do not require knowledge of computer code but may provide for the use of simplified expressions for further customization.

The subject technology employs a multi-layered approach to workflows that helps ensure that each revenue recovery action is precise, relevant, and effective. As discussed herein, a “trigger” may refer to a type of event that may be listened for and that causes the revenue recovery workflow to run and may include, for example, an invoice becoming overdue or a subscription being canceled. A “condition” may specify a particular context (e.g., customer attributes and/or transaction attributes) that may be met in order for the associated revenue recovery action(s) to run and may include, for example, particular customer types or invoice amounts to allow merchants to segment their customer base effectively and select the most appropriate revenue recovery actions for the specified trigger event. An “action” (e.g., a revenue recovery action) may refer to the tasks that may be performed by the workflow and may include, for example, sending an email or canceling a subscription. By allowing individual workflows for specific customers and/or scenarios, the subject system may reduce the number of computing resources (e.g., processing and/or memory resources) needed to collectively address different customer types and/or scenarios.

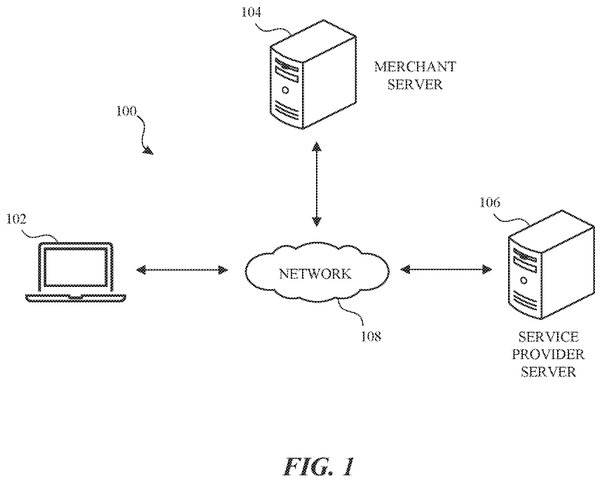

FIG. 1 illustrates an example network environment 100 in which the subject technology may be implemented, in accordance with one or more embodiments. Not all of the depicted components may be used in all embodiments, however, and one or more embodiments may include additional or different components than those shown in the figure. Variations in the arrangement and type of the components may be made without departing from the spirit or scope of the claims as set forth herein. Additional components, different components, or fewer components may be provided.

The network environment 100 may include an electronic device 102, a merchant server 104, and a service provider server 106. The network 108 may communicatively (directly or indirectly) couple one or more of the electronic device 102, the merchant server 104, and the service provider server 106. In one or more embodiments, the network 108 may be an interconnected network of devices that may include, or may be communicatively coupled to, the internet.

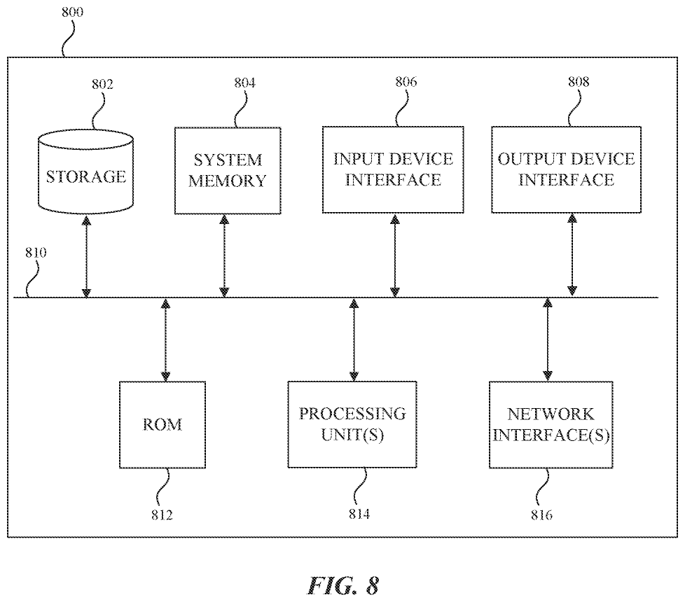

For explanatory purposes, the network environment 100 is illustrated in FIG. 1 as including the electronic device 102, the merchant server 104, and the service provider server 106; however, the network environment 100 may include any number of electronic devices and/or any number of servers communicatively coupled to each other directly or via the network 108. In addition, the various systems of FIG. 1 may be, and/or may include all or part of, the electronic system discussed below with respect to FIG. 8.

The electronic device 102 may be, for example, a wearable device (such as a watch, a band, and the like), a desktop computer, a portable computing device (e.g., a laptop computer), a smartphone, a peripheral device (e.g., a digital camera, headphones), a tablet device, or any other appropriate device that includes, for example, one or more wireless interfaces, such as WLAN radios, cellular radios, Bluetooth radios, Zigbee radios, near field communication (NFC) radios, and/or other wireless radios. In FIG. 1, by way of example, the electronic device 102 is depicted as a laptop computer. The electronic device 102 may be associated with one or more accounts, credentials, or any other identity information registered with the service provider server 106 belonging to a user associated with the electronic device 102.

The service provider server 106 may be and/or may include, for example, one or more servers that host or facilitate a service that may be used by one or more entities (e.g., the electronic device 102). For example, the service provider server 106 may belong to a payment processor, and the service may include a revenue recovery platform that may integrate with one or more merchants. The service provider server 106 may store account information (e.g., user account, usernames/handles, or any other account-specific data) associated with the electronic device 102 and/or users thereof and/or users associated therewith. The service provider server 106 may be, and/or may include all or part of, the electronic system discussed below with respect to FIG. 8.

The merchant server 104 may be and/or may include, for example, one or more servers that host or facilitate a service that may be used by one or more entities (e.g., the electronic device 102). For example, the merchant server 104 may belong to a merchant, and the service may include the sale and/or exchange of goods and/or services, which may be facilitated by one or more payment processors. The merchant server 104 may store account information (e.g., user account, usernames/handles, or any other account-specific data) associated with the electronic device 102 and/or users thereof and/or users associated therewith. The merchant server 104 may be, and/or may include all or part of, the electronic system discussed below with respect to FIG. 8.

The merchant server 104 may also generate one or more payment events. In one or more embodiments, a “payment event” may refer to a digital record or notification generated by the merchant server 104, signifying a particular activity related to, for example, the buying and selling of goods and/or services. For example, a payment event may represent a financial exchange, such as a customer purchasing a product, a client subscribing to a service, or any other form of monetary transaction facilitated by the merchant. The payment event not only documents the transaction but may also serve as a trigger for various downstream processes, such as inventory management, financial reconciliation, and customer communication. A payment event may bridge the merchant's operations with a broader financial ecosystem (e.g., including the service provider server 106), ensuring that every transaction is accounted for, processed, and archived appropriately.

In one or more embodiments, a payment event may correspond to and/or may include a “revenue recovery event” which may refer to a specialized electronic notification or alert generated by the merchant server 104 in instances where there is a discrepancy, failure, or other issue related to a payment event. A revenue recovery event could arise from scenarios like failed payments, declined credit cards, overdue invoices, or any other situation where expected revenue has not been realized. Once identified (e.g., by the merchant server 104), a revenue recovery event may be sent to the service provider server 106 (e.g., to a revenue recovery platform operated by the payment processor). Upon receiving a revenue recovery event, the revenue recovery platform may initiate one or more pre-defined revenue recovery workflows to perform one or more pre-defined actions in response. A revenue recovery workflow may involve actions such as sending reminders to customers about overdue payments, attempting to process the payment again, and/or escalating the issue for manual intervention. An objective of the revenue recovery event is to flag and address potentially lost revenue to improve the merchant's chance to recover funds.

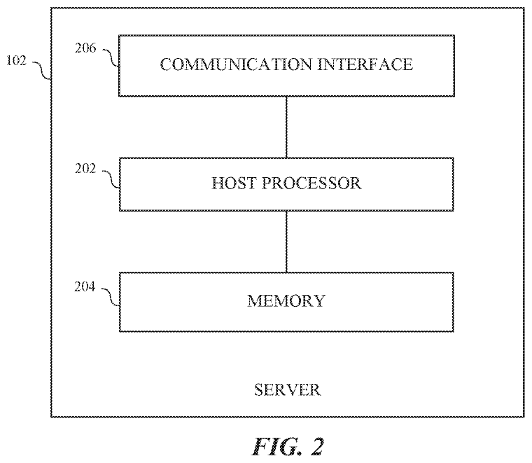

FIG. 2 depicts an example electronic device 102 that may implement the subject technology, in accordance with one or more embodiments. For explanatory purposes, FIG. 2 is primarily described herein with reference to the electronic device 102 of FIG. 1. However, this is merely illustrative, and features of the server of FIG. 2 may be implemented in any other electronic device for implementing the subject technology. Not all of the depicted components may be used in all embodiments, however, and one or more embodiments may include additional or different components than those shown in FIG. 2. Variations in the arrangement and type of the components may be made without departing from the spirit or scope of the claims as set forth herein. Additional components, different components, or fewer components may be provided.

The electronic device 102 may include one or more of a host processor 202, a memory 204, and/or a communication interface 206. The host processor 202 may include suitable logic, circuitry, and/or code that enable processing data and/or controlling operations of the electronic device 102. In this regard, the host processor 202 may be enabled to provide control signals to various other components of the electronic device 102. The host processor 202 may also control transfers of data between various portions of the electronic device 102. The host processor 202 may further implement an operating system or may otherwise execute code to manage operations of the electronic device 102.

The memory 204 may include suitable logic, circuitry, and/or code that enable storage of various types of information such as received data, generated data, code, and/or configuration information. The memory 204 may include volatile memory (e.g., random access memory (RAM)) and/or non-volatile memory (e.g., read-only memory (ROM), flash, and/or magnetic storage).

The communication interface 206 may include suitable logic, circuitry, and/or code that enables wired or wireless communication, such as between the electronic device 102, the merchant server 104, the service provider server 106, and/or the electronic device 102. The communication interface 206 may include, for example, one or more of a Bluetooth communication interface, an NFC interface, a Zigbee communication interface, a WLAN communication interface, a USB communication interface, a cellular interface, or generally any communication interface.

In one or more embodiments, one or more of the host processor 202, the memory 204, the communication interface 206, and/or one or more portions thereof may be implemented in software (e.g., subroutines and code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

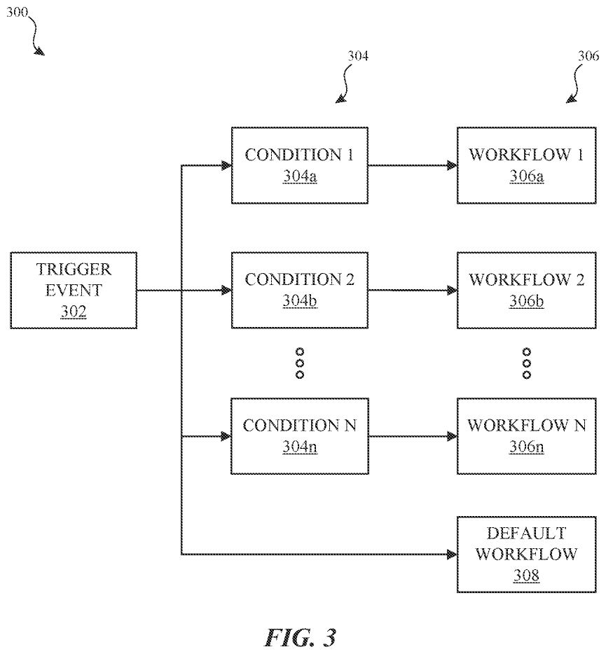

FIG. 3 illustrates a process flow diagram 300 for selectively performing revenue recovery workflows in response to trigger events, in accordance with one or more embodiments. Generally, a merchant (or another third party) may configure a set of workflows that are selectively performed in response to a trigger event. As described in more detail below, each workflow is selectively performed based on a priority and/or one or more trigger event conditions associated with the workflow. In some embodiments, trigger event conditions are specified using a custom expression that utilizes regular expressions (e.g., rational expressions). By utilizing custom expressions in this manner, a merchant may cover a variety of scenarios without explicitly and/or separately having to define each condition. A custom expression may encompass one or more conditions as illustrated in conditions 304. Not all depicted components may be used in all embodiments, however, and one or more embodiments may include additional or different components than those shown in the figure. Variations in the arrangement and type of the components may be made without departing from the spirit or scope of the claims as set forth herein. Additional components, different components, or fewer components may be provided.

As shown in FIG. 3, in an example operation, a trigger event may result in a prioritized order being executed in response to an associated condition matching a condition specified by a custom expression provided by a merchant. A trigger event 302 is detected. Trigger event 302 may be detected, for instance, by a merchant server, (e.g., merchant server 104 of FIG. 1), and in turn the merchant server may provide an indication (e.g., a signal, notification, or other indicator) to a service provider server (e.g., service provider server 106 of FIG. 1) that the trigger event 302 has been detected. In some examples, a trigger event may be detected by a service provider server directly, or a third party server. In some examples, the indication of trigger event 302 may include information (e.g., metadata) related to the trigger event 302, such as payment status, transaction amount, customer details, subscription type, and the like. In some examples, the merchant communicates the indication of the trigger event 302 to the service provider using an API and/or one or more other integration mechanisms.

In some examples, the trigger event is an event that has already occurred. For example, trigger event 302 may be a specified revenue recovery event such as a subscription payment failure, an invoice finalization, a canceled subscription, a scheduled cancelation of a subscription, an expiration of a quote, a due date set for an invoice, an overdue invoice, and the like. In some examples, trigger event 302 may be related to an event occurring in the future, such as a subscription that is scheduled to cancel or an invoice with an upcoming due date. This way, the merchant can specify conditions for performing workflows such that they are performed a predetermined amount of time (e.g., 30 days) before the event. For example, a workflow may be performed 30 days before an invoice becomes due provided the conditions for performing the workflow are satisfied.

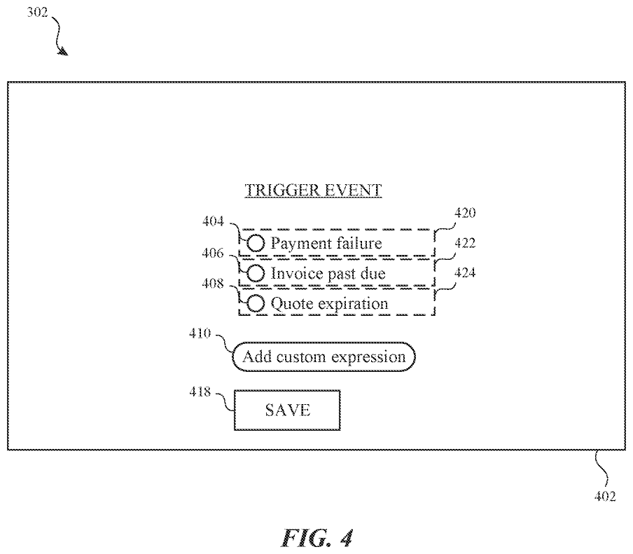

In some examples, trigger event 302 may trigger a variety of conditions that may be expressed using an expression evaluation language, such as Common Expression Language (CEL). CEL expressions enable merchants to provide custom expressions that cover a variety of scenarios such that each condition to workflow mapping does not need to be explicitly defined. Utilizing CEL expressions provides merchants with more flexibility and control over workflow-based automation. Such expressions are discussed in detail below, for instance, with respect to FIG. 4.

Upon receiving an indication of trigger event 302, the service provider server identifies workflows 306 associated with trigger event 302. Each of workflows 306 has a priority attribute indicating a respective priority of the workflow. In some examples, no workflows 306 share the same priority. In other embodiments, two or more workflows 306 may share the same priority and/or have no priority assigned.

Each workflow 306 is further associated with a respective set of recovery actions. Accordingly, in response to a particular trigger event, any number of actions may be taken based on one or more characteristics of the trigger event. By way of example, multiple workflows may exist for a “payment failure” trigger event. A first workflow may include recovery actions designed for high-value customers who, for example, have a history of substantial purchases and timely payments. Conditions associated with this workflow might include checking customer data such as if the customer has made purchases above a certain amount in the past and has had fewer than a specified number of payment failures. When these are met, indicating that the payment failure may be an anomaly rather than a pattern, the workflow initiates the appropriate recovery actions. A first action could be sending a personalized email expressing concern about the failed transaction and offering assistance. A second action could be scheduling a courtesy call from the customer service team to ensure that the customer receives a high level of support and to address any potential issues that led to the payment failure.

A second workflow for the “payment failure” trigger event might be directed to new customers or those with transaction data indicating, for example, a lower transaction volume. In this case, conditions would be met for customer data having a history of smaller transactions or indicating a newer account. When the conditions are met, indicating that the relationship is not yet well-established or the customer is less likely to respond to personalized outreach, the second workflow may initiate an action for sending an automated email with a link to update payment information. This email may be designed to be friendly yet direct, encouraging the customer to resolve the payment issue promptly and maintain their service or receive their product without the need for more personalized follow-up that the first workflow offers.

Recovery actions of a workflow 306 can encompass a wide array of functions specified by the merchant, which can range from automated tasks such as sending out templated communication messages (e.g., emails or SMS), initiating payment retries, updating database records, to more complex sequences such as triggering escalations for manual intervention by customer service teams, generating reports, or even invoking one or more remote server addresses (e.g., through accessing external APIs provided by the merchant and/or third parties) that integrate with other services or systems for additional actions, such as generating notifications for external messaging applications. In some embodiments, invoking one or more remote server addresses may be done so that these other services or systems may process the customer and/or transaction data stored on the service provider server. The configurability of recovery actions enables the merchant to tailor workflows to fit diverse operational scenarios. This means that the recovery actions are not merely pre-defined system operations but rather customized sequences of operations set up at least in part by the merchant. With the use of a graphical user interface (GUI) designed for creating these workflows, as described below, merchants can specify the parameters of each action without the need for deep technical knowledge or programming. By employing simplified expression languages or selecting options through the GUI, merchants can define what actions to take, under what circumstances, and in what sequence, allowing for a high degree of specificity and relevance to the merchant's business processes. The service provider server 106, which supports this flexibility, may be configured to interpret the merchant's configurations and translate them into operational sequences that interact with data, systems, and potentially even people to execute the specified steps of one or more workflows.

In some examples, the availability and range of recovery actions of workflows 306 may vary and may be intrinsically linked to the nature of the trigger event 302 and/or conditions 304. For example, when trigger event 302 is a subscription payment failure, actions may include setting a retry policy (e.g., defining how failed charges are retried), marking a subscription unpaid (e.g., subscription continues to generate invoices each billing cycle, which remain in a draft state), canceling a subscription (e.g., disabling creation of new invoices for the subscription), and the like. As another example, when trigger 302 is an overdue invoice, actions may include marking the invoice uncollectible (e.g., treating the invoice as bad debt in the accounting process), voiding the invoice (e.g., treating the invoice as a mistake and canceling the invoice), sending an email (e.g., notifying the customer about the overdue invoice), and the like.

In some examples, recovery actions may be performed by the service provider server or another server (e.g., the merchant server 104) via a webhook, API, or other integration. Example webhooks include a scheduled webhook to send and/or receive a reminder about a subscription that is about to end or a scheduled webhook to send and/or receive a reminder about an invoice that is about to be due.

Having identified each workflow 306 corresponding to trigger event 302 (e.g., all workflows for a particular merchant indicated as corresponding to an event type of trigger event 302), the service provider server evaluates the identified workflows in an order according to the respective priorities of the identified workflows until a workflow is identified to be performed (e.g., executed) or all workflows have been evaluated. The service provider server may, for instance, identify a workflow 306 having a highest priority (e.g., as indicated by the priority attribute of the workflow) and determine whether a set of conditions 304 corresponding to the workflow 306 are matched (e.g., satisfied, met) by trigger event 302 and/or any additional information corresponding to trigger event 302. By way of example, the service provider server may identify workflow 306a as having the highest priority of workflows 306 and determine whether corresponding conditions 304a match trigger event 302. If so, the service provider server performs workflow 306a. As described, performing workflow 306a includes performing one or more recovery actions associated with workflow 306a.

If the service provider server determines that conditions 304a do not match trigger event 302, the service provider server may identify workflow 306b having the next highest priority and determine whether a set of conditions corresponding to the workflow is met. As an example, the service provider server may identify workflow 306b as having the next highest priority of workflows 306 and determine whether corresponding conditions 304b match trigger event 302. If so, the service provider server performs workflow 306b. If not, the service provider server iteratively continues to identify a workflow having a next highest priority and evaluate whether conditions for the workflow are met until a workflow is identified, or until all workflows 306 have been evaluated with no match. In some examples, if all workflows have been evaluated and no match is identified, the service provider server performs a default workflow 308 associated with trigger event 302. Default workflow 308 includes one or more default recovery actions.

In some examples, one or more recovery actions of a workflow are assigned a priority such that when a workflow is performed, recovery actions of the workflow are performed according to their respective priorities. Additionally in some instances, recovery actions are performed according to context (e.g., metadata) of a trigger event. By way of example, a subset of a workflow's recovery actions may be performed for a particular type of user (e.g., monthly subscription user) whereas a different subset of the workflow's recovery actions may be performed for a different type of user (e.g., yearly subscription user).

In some examples, the framework by which conditions are generated provides a high degree of flexibility such that many different types of trigger events and different varieties of particular types of trigger events may be handled in specific ways. For instance, a condition may be as straightforward as a customer's account status, where if the account is marked as “delinquent,” the actions of the corresponding workflow are initiated. A condition could also be multifaceted, taking into account the customer data such as the customer's history (e.g., the frequency and amount of past purchases) or demographic factors (e.g., geographic location). For instance, if customer data indicates a customer has made large purchases in the past, indicating a higher value to the company, a corresponding workflow may be provided that implements a more personalized recovery approach. An action might include sending a series of escalating communications: initially, a polite payment reminder via email; following that, if there is no response, a text message; and eventually, if the payment remains outstanding, a scheduled phone call from a customer service representative. In more nuanced systems, the actions could involve adjusting the tone or language of the messages based on the past interactions with the customer. If customer data indicates that a customer frequently pays late but pays eventually, the action might include an offer for setting up a payment plan. Conversely, for a new customer with a first-time payment issue, the action might simply be a reminder with clear instructions on how to complete the payment process to reduce any confusion or technical barriers that could be preventing payment completion. Another action could involve more direct intervention, such as temporary account suspension until the overdue amount is settled, or in the case of a recurring service, triggering a downgrade to a lower service level.

In some embodiments, the availability and range of conditions 304 can vary and may be intrinsically linked to the nature of the trigger event 302. In some examples, each set of conditions 304 may include technical specifications and/or criteria pertaining to trigger event 302. In some examples, conditions 304 may be based on the data of a customer associated with the trigger event 302 (e.g., demographics, number of transactions, etc.) and/or based on the data of a transaction associated with the trigger event 302 (e.g., invoice amount, subscription interval, product sold, etc.). For example, if the trigger event 302 signals that the end of a subscription period has occurred, the conditions 304a, 304b might provide additional constraints directed to monthly and yearly subscriptions, respectively. The service provider server may obtain customer and transaction data through integration with various data sources and systems that are part of the merchant's operational infrastructure (also referred to herein as “merchant record”), such as the merchant's database systems, CRM software, payment gateways, and/or any other software via one or more data exchange protocols and/or APIs. For instance, when a transaction occurs, the payment gateway may process the payment and record the transaction details, which then may be sent to the merchant server. In some embodiments, the merchant may configure or define one or more fields of the merchant record for further customization (e.g., for reference in CEL expressions). The merchant server, upon logging the transaction, could generate a digital record in the merchant record such as a “payment event.” The payment event data may include transaction data such as relevant details about the transaction like the customer's identity, the amount paid, the payment status, and any associated invoice details. If a transaction fails or an invoice becomes overdue, the merchant record may be updated to reflect the new status, effectively creating a “revenue recovery event” (e.g., trigger event). The service provider server 106 may continually listen for such revenue recovery events. When a trigger event occurs, the service provider server may then access the detailed customer and/or transaction data related to that event to assist in evaluating conditions 304. The merchant record may also enrich revenue recovery events with additional customer data from the CRM, such as communication history or customer classification, to create a comprehensive view of the customer profile used by the conditions to accurately qualify the correct workflow path.

In some examples, mutual exclusivity may be enforced between workflows defined for the same trigger event. In some embodiments, hard enforcement of mutual exclusivity may apply meaning that it can be guaranteed that workflows sharing the same trigger will never conflict with each other, and that for every trigger 302 there will only ever be at most one workflow that should run (e.g., as defined by its trigger conditions and/or priority). In some embodiments, priorities may not have been specified and as a result soft enforcement of mutual exclusivity may apply meaning that it cannot be guaranteed that workflows sharing the same trigger would not conflict and that actions may be required to guarantee that only one workflow actually runs for a particular trigger event. For example, in a soft enforcement scenario, when multiple workflows are triggered, the user may be notified so that the user may select which workflow to perform and/or which workflows not to perform.

FIG. 4 depicts an example interface 402 for defining a trigger event, such as trigger event 302 (FIG. 3), in accordance with one or more embodiments. Not all depicted components may be used in all embodiments, however, and one or more embodiments may include additional or different components than those shown in the figure. Variations in the arrangement and type of the components may be made without departing from the spirit or scope of the claims as set forth herein. Additional components, different components, or fewer components may be provided.

The service provider server may generate and/or provide a user interface 402 for creating workflow automation. In some examples the user interface 402 may include an interface for creating, modifying, or customizing the trigger event 302 in the context of revenue recovery. The user may select a trigger event from a library of trigger events and drag and drop the trigger event in the workflow automation. The user interface 402 may be interactive, minimizing the need for coding or technical expertise. The user interface 402 may be graphical, providing users with a visual canvas where they can construct and adjust the trigger event 302 using a variety of graphical elements (e.g., button 418, checkboxes 404, 406, 408, etc.). The graphical elements may be moved (e.g., dragged and dropped), checked, interconnected, or otherwise manipulated to define the logic of the trigger event 302. The user interface 402 offers a centralized location for a merchant to view and/or modify the triggers events stored on the service provider server, which, for example, may reduce the number of requests that a merchant needs to send to the server to generate and/or manage trigger events, thereby reducing the processing, memory, and/or communication resources needed to manage such workflows. The interactive aspect of the user interface 402 allows non-technical users to customize workflows thereby conserving developer resources. The interactive aspects also provide added flexibility to perform modifications and updates to workflows without the need for a user to be proficient in coding and/or to delve into the code, as well as improve scalability by promoting code reusability.

As shown in FIG. 4, the user interface 402 may present a list of revenue recovery events from which the user may select to customize the trigger event 302. A user may select a revenue recovery event 420, 422, 424 to activate via a checkbox 404, 406, 408. For example, if the user wants the workflow associated with trigger event 302 to be activated in response to a payment failure, the user may check the checkbox 404.

In some embodiments, the user interface 402 may include a library of revenue recovery elements. The revenue recovery elements could represent various data points, conditions, and operators. For instance, there might be revenue recovery elements for “Payment Status,” “Invoice Status,” “Quote Status,” and logical operators like “AND,” “OR,” and “NOT.” Users may drag one or more revenue recovery elements onto the user interface 402. Once a revenue recovery element is on the user interface 402, context-sensitive options may appear. For example, dragging a “Payment Status” revenue recovery element might present a dropdown menu allowing users to select from options like “Failed,” “Pending,” or “Completed.” To create more complex conditions, users can interconnect condition elements using visual connectors or lines. For instance, a user might connect the “Payment Status” set to “Failed” with the “Subscription Type” set to “Annual” using an “AND” operator, indicating they would like to set a condition for failed payments specifically for annual subscriptions. For further ease of use, the user interface 402 may, optionally, also provide a real-time preview of the entire workflow automation in a summary pane. As users build or modify the trigger event 302, the summary pane may dynamically generate a plain-language description of the logic of the trigger event 302, ensuring users can verify the accuracy of the trigger 302. Once the trigger event 302 is defined, users may have the option to save (e.g., with button 418), test, or deploy the trigger event 302, to verify that the trigger event 302 may be properly integrated into a workflow.

In some embodiments, users may input a fully customizable expression to define the trigger event. Custom expressions 410 may be based on simplified expression evaluation languages, such as Common Expression Language (CEL) or regular expressions (regex). Custom expressions 410 are beneficial because they allow users to define trigger events and related logic in a more detailed and customized manner, thereby allowing merchants to dynamically address a broader range of scenarios that might not be covered by a fixed list of trigger events. The syntax of custom expressions 410, like CEL, may be closer to natural language and mathematical notation, making it more accessible to users who might not have a coding background and saving merchants the time and cost of engineering a complex codebase to perform similar tasks. For instance, instead of selecting a pre-defined condition for “annual subscriptions,” a user might use a custom expression 410 to specify conditions like “invoice past due for annual subscriptions that were upgraded from a monthly plan.”

In some embodiments, the user interface 402 that supports custom expressions 410 may include features such as syntax highlighting, auto-suggestions, and real-time error checking to guide users as they create expressions, and to help verify accuracy and reduce the likelihood of mistakes in the expressions created by merchants. Improving accuracy and reducing mistakes in custom expressions allows for rapid prototyping without the need for a full compilation of a codebase, thereby leading to shorter development cycles and reducing development computing needs. In some embodiments, the user interface 402 may support tooltips and inline documentation to provide instant context and clarification in creating or modifying the trigger event 302.

In some embodiments, while the merchant is interacting with the user interface 402 to visually compose and configure their workflows, the application rendering the GUIs (e.g., the web browser) may translate these graphical representations into computer code based on code snippets associated with the graphical elements of the user interface 402. This code generation may be dynamically generated and responsive to changes provided by the merchant (e.g., via the user interface 402) thereby saving the merchant time in development and debugging. In some embodiments, when the merchant has indicated that the modifications are completed (e.g., by pressing the “save” button 418), the merchant device running the application may send a request to the service provider server to generate, integrate, and/or deploy the computer code (e.g., into another codebase) to effectuate the specified functionality.

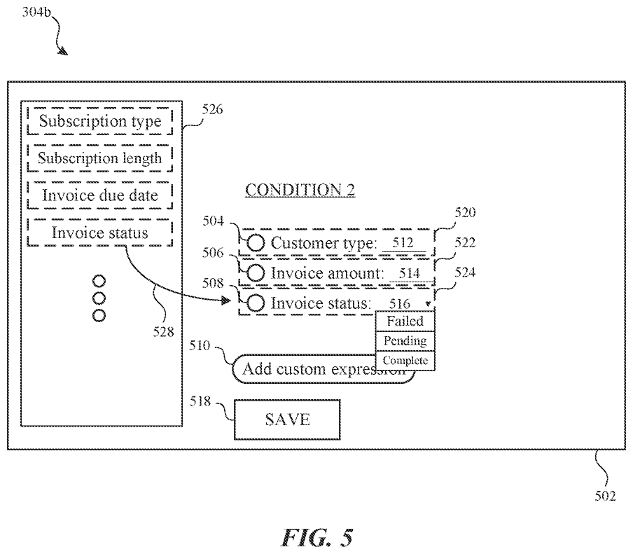

FIG. 5 depicts an example interface 502 for defining a set of conditions, such as a set of conditions 304a (FIG. 3), in accordance with one or more embodiments. Not all depicted components may be used in all embodiments, however, and one or more embodiments may include additional or different components than those shown in the figure. Variations in the arrangement and type of the components may be made without departing from the spirit or scope of the claims as set forth herein. Additional components, different components, or fewer components may be provided.

The service provider server may generate and/or provide a user interface 502 for creating, modifying, or customizing the condition in the context of revenue recovery. The user interface 502 may be similar to the user interface 402. The user interface 502 may be interactive, minimizing the need for coding or technical expertise. The user interface 502 may be graphical, providing users with a visual canvas where they can construct and adjust the condition using a variety of graphical elements (e.g., buttons 518, checkboxes 504, 506, 508, input fields 512, 514, etc.). The graphical elements may be moved (e.g., dragged and dropped), checked, interconnected, or otherwise manipulated to define the logic of the condition 304.

As shown in FIG. 5, the user interface 502 may present pre-defined or partially pre-defined condition elements 520, 522, 524 for a user to customize the condition 304. A user may select a condition element 520, 522, 524 to activate via a checkbox 504, 506, 508. For example, if the user wants the condition 304 to filter out payment events that are associated with an invoice having an amount below a specified amount, the user may check the checkbox 506 and input the specified amount into input field 514. A user may re-arrange the condition elements 520, 522, 524 (e.g., by dragging and dropping the elements) to define a priority by which they are evaluated.

In some embodiments, the user interface 502 may include a library of condition elements 526. The condition elements could represent various data points, conditions, and operators. For instance, there might be condition elements for “Invoice Status,” “Subscription Type,” “Invoice Amount,” and logical operators like “AND,” “OR,” and “NOT.” Users may drag (528) one or more condition elements onto the user interface 502. Once a condition element is on the user interface 502, context-sensitive options may appear. For example, dragging a “Invoice Status” condition element might present a dropdown menu 516 allowing users to select from options like “Failed,” “Pending,” or “Completed.” Similarly, if a user drags the “Transaction Amount” condition element, they might be presented with a fill-in-the-blank or slider interface to specify a particular amount or range. To create more complex conditions, users can interconnect condition elements using visual connectors or lines. For instance, a user might connect the “Invoice Status” set to “Failed” with the “Subscription Type” set to “Annual” using an “AND” connector, indicating they want to condition failed payments specifically for annual subscriptions. For further ease of use, the user interface 502 may also provide a real-time preview or summary pane. As users build or modify the condition, the summary pane may dynamically generate a plain-language description of the logic of the condition, ensuring users can verify the accuracy of the condition 304. Once the condition is defined, users may have button 518 to save, test, or deploy the condition, to verify that the condition 304 may be properly assigned to a workflow.

In some embodiments, users may input a fully customizable expression to define the condition. Custom expressions 510 may be based on simplified expression evaluation languages, such as CEL or regex. Custom expressions 510 allow users to define conditions and logic in a more detailed manner, as described above with respect to FIG. 4.

In some embodiments, the user interface 502 that supports custom expressions 510 may include features such as syntax highlighting, auto-suggestions, and real-time error checking to guide users as they create expressions, and to help verify accuracy and reduce the likelihood of mistakes in the expressions created by merchants. In some embodiments, the user interface 502 may support tooltips and inline documentation to provide instant context and clarification in creating or modifying the condition.

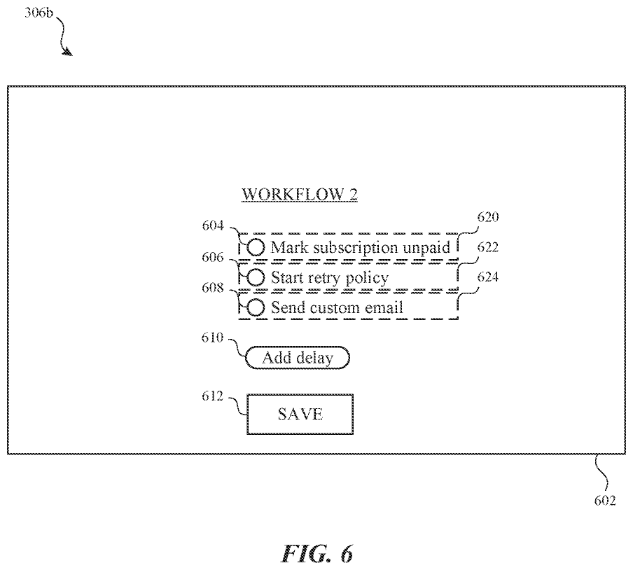

FIG. 6 depicts an example interface 602 for defining a workflow, such as workflow 306a (FIG. 3), in accordance with one or more embodiments. Not all depicted components may be used in all embodiments, however, and one or more embodiments may include additional or different components than those shown in the figure. Variations in the arrangement and type of the components may be made without departing from the spirit or scope of the claims as set forth herein. Additional components, different components, or fewer components may be provided.

The service provider server may generate and/or provide a user interface 602 for creating, modifying, or customizing the workflow in the context of revenue recovery. The user interface 602 may be similar to the user interface 402. The user interface 602 may be interactive, minimizing the need for coding or technical expertise. The user interface 602 may be graphical, providing users with a visual canvas where they can construct and adjust the workflow using a variety of graphical elements (e.g., buttons 612, checkboxes 604, 606, 608, input fields, etc.). The graphical elements may be moved (e.g., dragged and dropped), checked, interconnected, or otherwise manipulated to define the logic of the workflow.

As shown in FIG. 6, the user interface 602 may present pre-defined or partially pre-defined action elements 620, 622, 624 for a user to customize the workflow they want to be executed in response to specific triggers and conditions. A user may select an action element 620, 622, 624 to activate via a checkbox 604, 606, 608. In some embodiments, the user may select multiple recovery actions to be performed when performing the workflow. Users may drag and drop the recovery actions onto the canvas, positioning them in the sequence (e.g., priority) they desire for the actions to be executed.

In some embodiments, a library of available recovery actions may be presented. Each recovery action, which may be represented by distinct icons or labels, could range from sending an email, making an application programming interface (API) call, triggering a webhook, updating local records, to more complex operations.

In some embodiments, a contextual properties panel or window may be presented where users can delve into the specifics of the recovery action. For instance, if the action is to send an email, fields for recipient, subject, message body, and/or template selection would be available for further customization. If the action involves an API call, fields for endpoint uniform resource locator (URL), request type, headers, and/or payload may be presented.

To specify when actions are to be taken, users can set up time-based conditions or dependencies. For example, a delay element 610 can be introduced, allowing users to specify a waiting period before the workflow is executed. Additionally or alternatively, actions can be made dependent on the success or failure of a previous action, providing a logical flow of operations.

The user interface 602 may also support the specification of how the workflow is executed. If the workflow involves external systems, users can define the method of communication, such as APIs, webhooks, or direct database operations. A visual representation (e.g., in the form of branching paths or connectors) can illustrate the flow of data and the sequence of operations. For example, if a merchant wants to initiate a custom action outside of the revenue recovery system—such as notifying a third party logistics service of a payment failure that could affect shipping—the merchant could configure a webhook to be called when such a payment event occurs. The user interface 602 may allow merchants to set up this webhook by providing a visual interface where they could select a “webhook” action from a list of available action types. Then, the merchant may be presented with input fields to enter the URL of the third party service's API endpoint and to define the payload structure (e.g., including customer data such as the customer's ID and/or transaction data such as transaction amount and failed payment status). Moreover, within the user interface 602, there could be options to manage the responses from the webhook's request. If the third party service sends a response back, such as a confirmation of receipt or an error message, the merchant could configure subsequent actions based on this response using similar graphical elements, such as logging the response for auditing purposes, retrying the webhook if the initial attempt failed, or escalating the issue through other pre-defined workflows.

In some embodiments, as users construct their recovery actions for a workflow, the user interface 602 may provide validation, highlighting potential conflicts or issues to help verify that the designed actions are not only logically sound but also technically feasible, which may reduce the development and/or coding resources needed to generate a workflow.

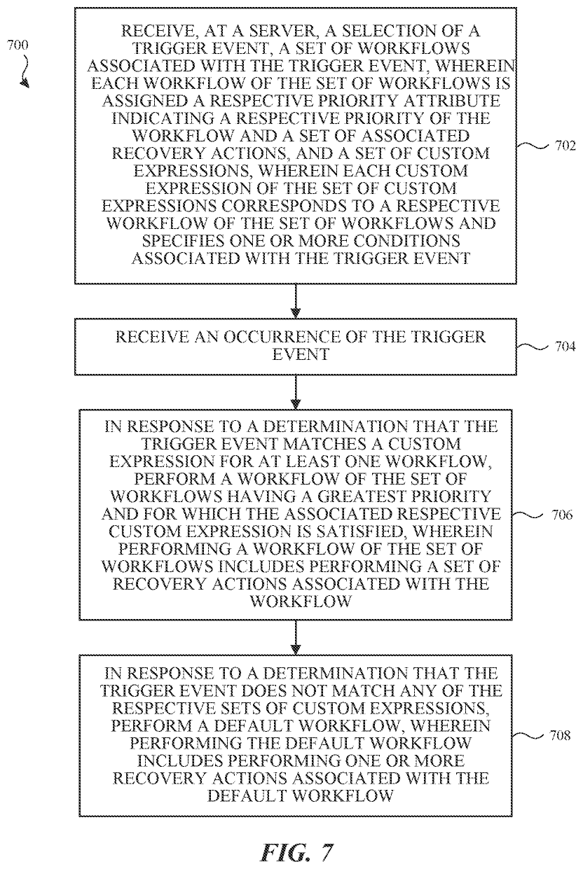

FIG. 7 depicts a flow diagram of an example process 700 for managing one or more revenue recovery workflows, in accordance with one or more embodiments. For explanatory purposes, the process 700 is primarily described herein with reference to the electronic device 102, the merchant server 104, and the service provider server 106 of FIG. 1. However, the process 700 is not limited to the electronic device 102, the merchant server 104, and the service provider server 106, and one or more blocks of the process 700 may be performed, wholly or in part, by one or more other by other suitable devices. Further, for explanatory purposes, the blocks of the process 700 are described herein as occurring sequentially or linearly. However, multiple blocks of the process 700 may occur in parallel. In addition, the blocks of the process 700 need not be performed in the order shown and/or one or more blocks of the process 700 need not be performed and/or can be replaced and/or supplemented by any number of other operations.

At block 702, a service provider server (e.g., the service provider server 106) receives, at a server, a selection of a trigger event, a set of workflows, and a set of custom expressions. In some examples, each workflow of the set of workflows is assigned a respective priority attribute indicating a respective priority of the workflow and a set of associated recovery actions. In some examples, each custom expression of the set of custom expressions corresponds to a respective workflow of the set of workflows and specifies one or more conditions associated with the trigger event.

In some examples, the service provider server receives the selection from a merchant device (e.g., the electronic device 102) and, accordingly, one or more of the trigger event, set of workflows, and set of custom expressions are associated with a merchant associated with the merchant device. The merchant may be associated with a merchant record, which includes data relating to customers of the merchant and/or data relating to transactions of the merchant. Each trigger event (e.g., the trigger 302) may be associated with zero or one default workflows, which may be user configured or pre-configured.

In some examples to facilitate receipt of the selection, the service provider server may generate one or more interactive graphical user interfaces (e.g., user interface 402) that, for example, can be run on a merchant's web browser and from which the merchant may provide the information to the service provider server to create and/or configure one or more workflows. In particular, in some examples the service provider server causes display of the user interface. In some examples, the user interface includes one or more configurable user interface elements for a customizable automation including a trigger event, a custom expression (e.g., a trigger event condition), a workflow, or a combination thereof.

The trigger event, defined or refined based on the merchant input to the first user interface, may serve as the guiding parameters that specify the revenue recovery events handled by corresponding workflows. The first user interface (e.g., user interface 402) may be generated by the service provider server, presented by a merchant device (e.g., the electronic device 102), and populated with one or more expression elements (e.g., the revenue recovery events 420, 422, 424). The first user interface may be provided to a merchant device (e.g., via the internet) for the merchant to provide information relating to the trigger event.

When a merchant interacts with the first user interface, they may be presented with an array of available expression elements. The merchant can then make selections based on their desired criteria for triggering the revenue recovery workflow to create a merchant-configured custom expression. The selection process may be facilitated through various interactive components of the first user interface, such as checkboxes, dropdown menus, and/or drag-and-drop functionalities. The merchant may also or instead provide a custom expression (e.g., CEL expression or other text data) to define the custom expression. The service provider server (e.g., via the request) may register these selections and/or custom expressions. For example, the service provider server can associate the custom expressions with a specified trigger event and/or workflow.

The merchant-configured expressions (or “conditions”), defined or refined based on the received merchant input, serve as the guiding parameters that define the particular conditions by which a workflow is performed in response to a trigger event. The second user interface (e.g., user interface 502) may be generated by the service provider server, presented by a merchant device (e.g., the electronic device 102), and populated with one or more condition elements (e.g., condition elements 520-524). The second user interface may be provided to a merchant device (e.g., via the internet) for the merchant to provide information relating to conditions. Each condition element in the second user interface may represent a particular criterion or parameter that can be used to define when and/or how a workflow should be initiated or modified. Condition elements could range from transaction criteria, such as payment status or subscription type, to customer criteria, such as customer status or interaction history.

When a merchant interacts with the second user interface, the merchant may be presented with an array of available condition elements. The merchant can then make selections and/or modify their desired criteria for selectively performing a workflow. The selection process may be facilitated through various interactive components of the user interface, such as checkboxes, dropdown menus, and/or drag-and-drop functionalities. The merchant may also or instead provide a custom expression (e.g., CEL expression or other text data) to define the conditions. The service provider server (e.g., via the request) may register these selections and/or custom expressions to build the workflow.

Recovery actions, defined or refined based on the received merchant input, define how the service provider server will respond and operate when confronted with specific revenue recovery scenarios (e.g., defined by the triggers and/or conditions). A third user interface (e.g., user interface 602) may be generated by the service provider server, presented by a merchant device (e.g., the electronic device 102), and populated with one or more action elements (e.g., action elements 620-624). The third user interface may be provided to a merchant device (e.g., via the internet) for the merchant to provide information relating to recovery actions of a workflow. Each action element in the third user interface may represent a specific set of operational responses or tasks that can be executed as part of a revenue recovery strategy. The action elements may encompass a variety of actions, such as sending reminder emails, initiating payment retries, logging transactional errors, and/or escalating unresolved issues to dedicated revenue recovery teams. In some examples, one or more recovery actions can include initializing and/or performing another workflow and/or causing a recovery action to be performed at a third party server, such as a merchant server.

When a merchant interacts with the third user interface, they may be presented with an array of available action elements. Merchants can then select and/or modify the desired actions they wish to assign to and/or include in a corresponding workflow. The selection process may be facilitated through various interactive components of the user interface, such as checkboxes, dropdown menus, and/or drag-and-drop functionalities. For example, action elements may be selected by clicking a check box and actions may be prioritized by dragging one action element ahead of another action element. The service provider server (e.g., via the request) may register the selected actions to build the workflow.

At block 704, the service provider server receives (e.g., identifies, determines, observes) an occurrence of a trigger event. In some examples, receiving an occurrence of a trigger event includes receiving an indication from a merchant server (e.g., the merchant server 104) that a trigger event has occurred or will occur at a particular date and/or time. The indication may be a message, signal, or any other form of notification about the occurrence of a revenue recovery event, which may be specified events (e.g., anomalies or problems) relating to a transaction involving the merchant server.

The service provider server may be in a listening state, awaiting indications that a revenue recovery event has occurred (or will occur in the future at a particular date and/or time). The indication may include data that provides context and/or details about the event. The data included with the indication may encompass various attributes such as the nature of the payment event, timestamp, payment method used, information about the customer corresponding to the payment event, and/or the specific reason for the revenue recovery event.

In one or more embodiments, a source of the indication may be the merchant server (e.g., the merchant server 104), which may be a central hub managing and processing various payment events (e.g., related to the sale of goods or services) for the merchant. When the merchant server detects an anomaly or problem that qualifies as a revenue recovery event of a specified type, the merchant server may package the relevant information and transmit the package to the service provider server. For example, the indication may include a comprehensive snapshot of the event, detailing attributes like transaction type, customer profile, payment method, and the specific nature of the payment failure. The transmission may be facilitated through secure communication channels, which may employ protocols such as APIs or webhooks, ensuring that the data exchange is timely and reliable.

Upon receiving the indication, the service provider server can determine whether the event (or one or more characteristics thereof) matches (e.g., satisfies) a custom expression for one or more workflows corresponding to the trigger event.

At block 706, in response to a determination that the trigger event matches a custom expression for at least one workflow, the service provider server performs a workflow of the set of workflows having a greatest priority and for which the associated respective custom expression is satisfied. In some examples, performing a workflow of the set of workflows includes performing a set of recovery actions associated with the workflow.

In some examples, performing the set of recovery actions associated with the workflow comprises executing at least one of the one or more recovery actions based on a predetermined delay.

In some examples, performing the set of recovery actions associated with the workflow includes performing the set of recovery actions according to a respective priority of at least two recovery actions of the set of recovery actions.

In some examples, performing the set of recovery actions associated with the workflow includes performing at least one recovery action of another workflow of the set of workflows.

In some examples, at least one recovery action is a service performed by a third party. For example, the service provider server can cause another server, such as a merchant server to perform the at least one recovery action.

In some examples, a workflow utilizes third party metadata to perform at least one recovery action.

At block 708, in response to a determination that the trigger event does not match any of the respective sets of custom expressions, the service provider server performs a default workflow. In some examples, performing the default workflow includes performing one or more recovery actions associated with the default workflow.

In some examples, determining whether a trigger event matches a custom expression for at least one workflow includes evaluating the set of workflows in an order according to the respective priorities of each workflow until a workflow is identified to be executed. For example, the service provider server can identify one or more workflows corresponding to the trigger event and determine which of the identified workflows has a highest priority as indicated by a priority attribute of the workflows. The service provider server then determines whether a custom expression of the highest-priority workflow is matched by the trigger event. If so, the service provider server performs the highest-priority workflow. If not, the service provider server determines whether a custom expression of the second highest-priority workflow is matched by the trigger event. If so, the service provider server performs the second highest-priority workflow. In this manner, the service provider server iteratively evaluates each of the identified workflow according to the respective priorities of the identified workflows until a match is found or until all workflows have been evaluated. In some examples, if no match is found, the service provider server performs a default workflow corresponding to the trigger event.

In some embodiments, the trigger event condition may include a future trigger corresponding to a future event. For example, the future trigger may be an invoice coming due in 30 days, and based on the future trigger, the corresponding workflow may be triggered upon the start of the 30^{th} day before the due date of the invoice.

In some examples, a revenue recovery action can encompass a wide range of responses, tailored to the nature and severity of the detected discrepancy. For instance, if the condition identifies a failed payment transaction, the corresponding action might involve automatically retrying the payment, notifying the customer of the failure, or logging an account associated with the revenue recovery event as uncollectible.

From a service provider server perspective, the execution of a revenue recovery action may involve a combination of internal processing and external communications. The revenue recovery action might call for database updates, API calls, generation of notifications, or even integrations with third party services like CRM systems. Example workflows may include sending a reminder email when an invoice is overdue, canceling a subscription when a customer reaches a credit limit, sending a survey to customers who cancel their subscriptions, automatically retrying failed payments, and marking invoices as uncollectible after a certain period of time.

In some embodiments, performing the recovery action may include scheduling the performance of the recovery action based on a merchant-configured delay. For example, the action may include scheduling a customized email to be sent in one week.

In some examples, the service provider server updates the merchant record based at least in part on one or more actions that were performed as part of a workflow. The merchant record includes data relating to customers of the merchant and/or data relating to transactions of the merchant. The data of the merchant and/or the transaction corresponding to the recovery event (e.g., which triggered a workflow) may be updated to reflect actions taken in response to a trigger event. For example, if a reminder email was sent to a customer when an invoice is overdue, the service provider server may update the customer data of a customer associated with the invoice to indicate that a reminder email was sent and that the invoice is overdue. As another example, if payment was retried because of a payment failure, the transaction data corresponding to the payment may be updated to reflect the time of the second attempted payment and the customer data corresponding to the payment may be updated to indicate the payment failure.

In some embodiments, customer and transaction data of the merchant record includes one or more merchant-configured fields, each merchant-configured field including a string key corresponding to a string field. For example, a merchant can set any string value as a key value and any other string value as the corresponding field value.

FIG. 8 depicts an example electronic system 800 with which aspects of the present disclosure may be implemented, in accordance with one or more embodiments. The electronic system 800 can be, and/or can be a part of, any electronic device for generating the features and processes described in reference to FIGS. 1-7, including but not limited to a laptop computer, tablet computer, smartphone, and wearable device (e.g., smartwatch, fitness band). The electronic system 800 may include various types of computer-readable media and interfaces for various other types of computer-readable media. The electronic system 800 includes one or more processing unit(s) 814, a persistent storage device 802, a system memory 804 (and/or buffer), an input device interface 806, an output device interface 808, a bus 810, a ROM 812, one or more processing unit(s) 814, one or more network interface(s) 816, and/or subsets and variations thereof.

The bus 810 collectively represents all system, peripheral, and chipset buses that communicatively connect the numerous internal devices of the electronic system 800. In one or more embodiments, the bus 810 communicatively connects the one or more processing unit(s) 814 with the ROM 812, the system memory 804, and the persistent storage device 802. From these various memory units, the one or more processing unit(s) 814 retrieves instructions to execute and data to process in order to execute the processes of the subject disclosure. The one or more processing unit(s) 814 can be a single processor or a multi-core processor in different embodiments.

The ROM 812 stores static data and instructions that are needed by the one or more processing unit(s) 814 and other modules of the electronic system 800. The persistent storage device 802, on the other hand, may be a read-and-write memory device. The persistent storage device 802 may be a non-volatile memory unit that stores instructions and data even when the electronic system 800 is off. In one or more embodiments, a mass-storage device (such as a magnetic or optical disk and its corresponding disk drive) may be used as the persistent storage device 802.

In one or more embodiments, a removable storage device (such as a floppy disk, flash drive, and its corresponding disk drive) may be used as the persistent storage device 802. Like the persistent storage device 802, the system memory 804 may be a read-and-write memory device. However, unlike the persistent storage device 802, the system memory 804 may be a volatile read-and-write memory, such as RAM. The system memory 804 may store any of the instructions and data that one or more processing unit(s) 814 may need at runtime. In one or more embodiments, the processes of the subject disclosure are stored in the system memory 804, the persistent storage device 802, and/or the ROM 812. From these various memory units, the one or more processing unit(s) 814 retrieves instructions to execute and data to process in order to execute the processes of one or more embodiments.

The bus 810 also connects to the input device interfaces 806 and output device interfaces 808. The input device interface 806 enables a user to communicate information and select commands to the electronic system 800. Input devices that may be used with the input device interface 806 may include, for example, alphanumeric keyboards, touch screens, and pointing devices. The output device interface 808 may enable the electronic system 800 to communicate information to users. For example, the output device interface 808 may provide the display of images generated by electronic system 800. Output devices that may be used with the output device interface 808 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information. One or more embodiments may include devices that function as both input and output devices, such as a touchscreen. In these embodiments, feedback provided to the user can be any form of sensory feedback, such as visual feedback, auditory feedback, or tactile feedback; and input from the user can be received in any form, including acoustic, speech, or tactile input.

The bus 810 also couples the electronic system 800 to one or more networks and/or to one or more network nodes through the one or more network interface(s) 816. In this manner, the electronic system 800 can be a part of a network of computers (such as a local area network, a wide area network, an intranet, or a network of networks, such as the internet). Any or all components of the electronic system 800 can be used in conjunction with the subject disclosure.

Embodiments within the scope of the present disclosure can be partially or entirely realized using a tangible computer-readable storage medium (or multiple tangible computer-readable storage media of one or more types) encoding one or more computer-readable instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more embodiments, the tangible computer-readable storage medium can be directly coupled to a computing device, while in other embodiments, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessors or multi-core processors that execute software, one or more embodiments are performed by one or more integrated circuits, such as ASICs or FPGAs. In one or more embodiments, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon design preferences, it is understood that the specific order or hierarchy of blocks in the processes may be re-arranged, or that all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together into a single software product or packaged into multiple software products.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed, rather, the phrase allows a meaning that includes at least one of any one of the items, and/or at least one of any combination of the items, and/or at least one of each of the items. By way of example, the phrases “at least one of A, B, and C” or “at least one of A, B, or C” each refers to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more embodiments, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, one or more implementations, an embodiment, the embodiment, another embodiment, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method comprising:
receiving, at a server, a selection of:
a trigger event;
a set of workflows associated with the trigger event, wherein each workflow of the set of workflows is assigned a respective priority attribute indicating a respective priority of the workflow and a set of associated recovery actions; and
a set of custom expressions, wherein each custom expression of the set of custom expressions corresponds to a respective workflow of the set of workflows and specifies one or more conditions associated with the trigger event;
receiving an occurrence of the trigger event;
in response to a determination that the trigger event matches a custom expression for at least one workflow, performing a workflow of the set of workflows having a greatest priority and for which the associated respective custom expression is satisfied, wherein performing a workflow of the set of workflows includes performing a set of recovery actions associated with the workflow; and
in response to a determination that the trigger event does not match any of the respective sets of custom expressions, performing a default workflow, wherein performing the default workflow includes performing one or more recovery actions associated with the default workflow.

2. The method of claim 1, wherein performing the set of recovery actions associated with the workflow comprises executing at least one of the one or more recovery actions based on a predetermined delay.

3. The method of claim 1, wherein performing the set of recovery actions associated with the workflow includes performing the set of recovery actions according to a respective priority of at least two recovery actions of the set of recovery actions.

4. The method of claim 1, further comprising:
evaluating the set of workflows in an order according to the respective priorities of each workflow until a workflow is identified to be executed.

5. The method of claim 1, wherein the trigger event is based on an event occurring on a future date.

6. The method of claim 1, wherein performing the set of recovery actions associated with the workflow includes performing at least one recovery action of another workflow of the set of workflows.

7. The method of claim 1, wherein at least one recovery action is a service performed by a third party.

8. The method of claim 1, further comprising:
causing display of a user interface, by a server, wherein the user interface includes one or more configurable user interface elements for a customizable automation including a trigger event, a custom expression, a workflow, or a combination thereof.

9. The method of claim 1, wherein a workflow utilizes third party metadata to perform at least one recovery action.

10. An electronic device comprising:
a memory; and
a processor configured to:
receive, at the electronic device, a selection of:
a trigger event;
a set of workflows associated with the trigger event, wherein each workflow of the set of workflows is assigned a respective priority attribute indicating a respective priority of the workflow and a set of associated recovery actions; and
a set of custom expressions, wherein each custom expression of the set of custom expressions corresponds to a respective workflow of the set of workflows and specifies one or more conditions associated with the trigger event;
receive an occurrence of the trigger event;
in response to a determination that the trigger event matches a custom expression for at least one workflow, perform a workflow of the set of workflows having a greatest priority and for which the associated respective custom expression is satisfied, wherein performing a workflow of the set of workflows includes performing a set of recovery actions associated with the workflow; and
in response to a determination that the trigger event does not match any of the respective sets of custom expressions, perform a default workflow, wherein performing the default workflow includes performing one or more recovery actions associated with the default workflow.

11. The electronic device of claim 10, wherein performing the set of recovery actions associated with the workflow comprises executing at least one of the one or more recovery actions based on a predetermined delay.

12. The electronic device of claim 10, wherein performing the set of recovery actions associated with the workflow includes performing the set of recovery actions according to a respective priority of at least two recovery actions of the set of recovery actions.

13. The electronic device of claim 10, the processor is further configured to:
evaluate the set of workflows in an order according to the respective priorities of each workflow until a workflow is identified to be executed.

14. The electronic device of claim 10, wherein the trigger event is based on an event occurring on a future date.

15. The electronic device of claim 10, wherein performing the set of recovery actions associated with the workflow includes performing at least one recovery action of another workflow of the set of workflows.

16. The electronic device of claim 10, wherein at least one recovery action is a service performed by a third party.

17. The electronic device of claim 10, the processor is further configured to:
cause display of a user interface, by a server, wherein the user interface includes one or more configurable user interface elements for a customizable automation including a trigger event, a custom expression, a workflow, or a combination thereof.

18. The electronic device of claim 10, wherein a workflow utilizes third party metadata to perform at least one recovery action.

19. A non-transitory computer-readable medium comprising:
computer-readable instructions that, when executed by a processor, cause the processor to perform one or more operations comprising:
receiving, at a server, a selection of:
a trigger event;
a set of workflows associated with the trigger event, wherein each workflow of the set of workflows is assigned a respective priority attribute indicating a respective priority of the workflow and a set of associated recovery actions; and
a set of custom expressions, wherein each custom expression of the set of custom expressions corresponds to a respective workflow of the set of workflows and specifies one or more conditions associated with the trigger event;
receiving an occurrence of the trigger event;
in response to a determination that the trigger event matches a custom expression for at least one workflow, performing a workflow of the set of workflows having a greatest priority and for which the associated respective custom expression is satisfied, wherein performing a workflow of the set of workflows includes performing a set of recovery actions associated with the workflow; and
in response to a determination that the trigger event does not match any of the respective sets of custom expressions, performing a default workflow, wherein performing the default workflow includes performing one or more recovery actions associated with the default workflow.

20. The non-transitory computer-readable medium of claim 19, wherein performing the set of recovery actions associated with the workflow comprises executing at least one of the one or more recovery actions based on a predetermined delay.
